(19) United States
(12) Patent Application Publication
(10) Pub. No.: US 2013/0080254 A1
(43) Pub. Date: Mar. 28, 2013

(54) Electric Vehicle Charging Station with Connectivity to Mobile Devices to Provide Local Information

(71) Applicant: Jeff Thramann, Longmont, CO (US)

(72) Inventor: Jeff Thramann, Longmont, CO (US)

(21) Appl. No.: 13/623,515

(22) Filed: Sep. 20, 2012

Related U.S. Application Data
(60) Provisional application No. 61/537,319, filed on Sep. 21, 2011.
(60) Provisional application No. 61/608,425, filed on Mar. 8, 2012.

(51) Int. Cl. G06Q 30/02; H02J 7/00

(52) U.S. Cl. 705/14.57; 320/101

(57) ABSTRACT

A solar canopy is provided where the solar canopy includes at least one photovoltaic cell to provide power. The power is used as a renewable power source for a station that comprises at least one wireless enabled processor. The wireless enabled processor detects and establishes a communication link with a mobile, wireless enabled, processor in a transmission range. Data is transmitted from the processor to the mobile wireless enabled device over the communication link where the data relates to information associated with local establishments, such as, for example, stores, restaurants, governmental agencies, or the like. The solar canopy also may be provided with the ability to couple to a battery, which may be a vehicle battery such as an electric car or electric scooter. The solar canopy would provide electrical energy either directly to the battery or through a power conditioner and, optionally, a storage facility.

### CLAIM OF PRIORITY UNDER 35 U.S.C. §119

The present application claims priority to U.S. Provisional Patent Application Ser. No. 61/537,319, filed Sep. 21, 2011, U.S. Provisional Patent Application Ser. No. 61/608,425, filed Mar. 8, 2012, which are both incorporated herein by reference as if set out in full.

### CLAIM OF PRIORITY UNDER 35 U.S.C. §120

None.

### REFERENCE TO CO-PENDING APPLICATIONS FOR PATENT

The present Application for Patent is related to co-Pending U.S. Provisional Patent Application Ser. No. 61/537,346, filed Sep. 21, 2011, U.S. Provisional Patent Application Ser. No. 61/537, 412, filed Sep. 21, 2011, U.S. Provisional Patent Application Ser. No. 61/608,439, filed Mar. 8, 2012, and U.S. Provisional Patent Application Ser. No. 61/621,250, filed Apr. 6, 2012, all of which are incorporated herein by reference as if set out in full.

### BACKGROUND

1. Field

The technology of the present application relates generally to electric vehicle networks, and more specifically, to electric vehicle charging stations where the energy to charge the vehicle is generated using predominately renewable energy sources as well as providing ancillary services to augment and reduce the cost associated with the station. The ancillary services may be provided by certain facilities without incorporation of an electric vehicle charging capability.

2. Background

As countries become more concerned with oil reserves, renewable energy, and carbon footprints, electrically powered vehicles become more popular. Electrically powered vehicles have been around for some time in the form of mass transportation systems, such as, for example, subways, trolleys, and certain trains and light rail transportation vehicles. Within the last several years, hybrid and fully electric cars have become increasingly attractive, but have not generated a significant amount of demand. Such vehicles include, for example, the Toyota Prius, the Nissan Leaf, to name but two such electric vehicles.

Electric vehicles, and particularly individual or low occupancy vehicles, have several potential benefits over gas powered internal combustion automobiles. For example, hybrid and fully electric cars generate significantly less pollution than gas powered cars. While fully electric cars produce essentially zero pollution themselves, the generation of energy to charge the cars does produce some increase in pollution, although it is difficult to attribute any specific amount to the increase in grid power. Additionally, hybrid and fully electric cars are less influenced by changes in the price of a barrel of oil, whether the oil is based on foreign or domestic production. While these are some, many other benefits exist regarding the use of hybrid or fully electric vehicles.

While several advantages exist regarding electric vehicles, consumer demand for the same has been generally lower than expected in a number of major markets around the world. One of the factors resulting in lower than expected demand is simply the costs associated with the electric vehicles and, in particular, the cost of the large battery necessary to power the vehicle. Another factor resulting in the lower demand relates to the availability of electric vehicle charging stations (EVC stations). EVC stations, unlike gas stations, are not common place in most metropolitan areas, let alone less populated and rural regions. Many users of electric vehicles use their residential power to charge the battery, which limits the available range of electric vehicles. Also, residential power requires a significant amount of time to fully charge a vehicle battery.

To make EVC stations more readily available, electric vehicle networks are being proposed. Generally, electric vehicle networks provide for publicly-accessible EVC stations and battery stations in particular regions. The electric vehicle networks may be, depending on the locale, privately funded or governmentally funded. For example, Better Place, Inc., a corporation organized under the laws of the State of Delaware in the United States, is a venture back company whose mission is to reduce global dependency on hydrocarbons. Better Place is building an electric vehicle network that comprises multiple EVC stations in Israel. Better Place is currently contemplating the opening of electric vehicle networks in other jurisdictions as well. Another venture similar to Better Place, Inc. is Europe's Park & Charge. Park & Charge was originally funded by a European agency, but is now operated by the Electromobile Club of Switzerland.

However, even with organizations such as Better Place, Inc., Park & Charge, and others, the widespread application of EVC stations has been slow. Also, many EVC stations operate off of the electrical power grid. As much of the energy available from the electrical power grid is not renewable, and in some cases is petroleum based, even widespread application of EVC stations connected to the grid is less than desirable as petroleum dependency and pollution reduction will, in part, be offset by an increase in power requirements from commercial power plants.

Ideally, EVC stations would be powered by renewable power sources, such as, for example, photovoltaic (solar) arrays or wind turbines. The EVC stations, and electric vehicle networks, could further reduce petroleum dependency by supplying unused energy back to the grid.

However, despite the altruistic endeavors, including those described above, the capital costs associated with placement of EVC stations that use solar or wind energy to charge the vehicles has been a hindrance in widespread construction of EVC stations that use renewable energy. This is due, in part, to the long period of time that is required to recoup the capital construction costs by simply charging for the energy production.

Thus, against this background, there is a need to provide an improved EVC station that would augment the return on investment in the EVC stations to facilitate increased placement of renewable energy based EVC stations.

### SUMMARY

This Summary is provided to introduce a selection of concepts in a simplified and incomplete manner highlighting some of the aspects further described in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology of the present application, a solar canopy is provided that powers, among other things, a station. The station provides data transfer between the station and client devices of data registered with the station or registered with a remote server networked to the station. The data relates to information associated with local establishments, such as, for example, stores, restaurants, governmental agencies, or the like.

In other aspects of the technology of the present application, the solar canopy may further be provided with the ability to couple to a battery, which may be a vehicle battery, such as an electric car or electric scooter. The solar canopy would provide electrical energy either directly to the battery or through a power conditioner and, optionally, a storage facility. Electrical energy may be further supplied to the power grid, local establishments, street lamps, traffic lights, or the like.

These and other aspects of the technology of the present application will be apparent after consideration of the Detailed Description and Figures herein. It is to be understood, however, that the scope of the application shall be determined by the claims as issued and not by whether given subject matter addresses any or all issues noted in the Background or includes any features or aspects highlighted in this Summary.

### BRIEF DESCRIPTION OF THE DRAWINGS

FIG. 1 is a view of a solar canopy consistent with the technology of the present application;

FIG. 2 is a view of a pedestal consistent with the technology of the present application;

FIG. 3 is a view of a solar canopy consistent with the technology of the present application;

FIG. 4 is a view of a charge station consistent with the technology of the present application; and

FIG. 5 is a functional block diagram of a processor associated with the charge station consistent with the technology of the present application;

FIG. 6 is a functional block diagram of a portion of the processor associated with the technology of the present application;

FIG. 7 is a functional block diagram of a portion of the processor associated with the technology of the present application;

FIG. 8 is a methodology associated with using the technology of the present application;

FIG. 9 is a functional block diagram of a system capable of embodying portions of the technology of the present application;

FIG. 10 is another functional block diagram of a system capable of embodying portions of the technology of the present application;

FIG. 11 is a functional block diagram of a system consistent with the technology of the present application; and

FIG. 12 is a methodology associated with using the technology of the present application.

### DETAILED DESCRIPTION

The technology of the present patent application will now be explained with reference to various figures, tables, and the like. While the technology of the present application is described with respect to using canopy structures and solar or photovoltaic panels to produce renewable energy to charge vehicles or other batteries, the technology should not be limited to the same. In particular, one of ordinary skill in the art would now recognize that the technology is applicable to other renewable energy sources, or greener energy sources, such as, for example, wind power, as well as direct grid power supply. Moreover, the technology of the present application may be described with respect to charging large capacity batteries, such as, for example, those batteries used to power electric vehicles. One of skill in the art will now recognize on reading the disclosure that the technology may be applicable to charging batteries for other devices, such as personal people movers, electric scooters, mobile processing devices, or the like. In still certain embodiments, facilities may be provided that do not include battery charging capability but simply the ability to supply some of the services described herein. These facilities may be stand alone facilities providing services, such as, for example, areas with little or no vehicle traffic like smaller sized gated communities, malls, or the like, or be integrated as service places associated with a larger EVC station network. Moreover, the technology of the present patent application will be described with reference to certain exemplary embodiments herein. The word “exemplary” is used herein to mean “serving as an example, instance, or illustration.” Any embodiment described herein as “exemplary” is not necessarily to be construed as preferred or advantageous over other embodiments absent a specific indication that such an embodiment is preferred or advantageous over other embodiments. Moreover, in certain instances, only a single “exemplary” embodiment is provided. A single example is not necessarily to be construed as the only embodiment. The detailed description includes specific details for the purpose of providing a thorough understanding of the technology of the present patent application. However, on reading the disclosure, it will be apparent to those skilled in the art that the technology of the present patent application may be practiced with or without these specific details. In some descriptions herein, generally understood structures and devices may be shown in block diagrams to aid in understanding the technology of the present patent application without obscuring the technology herein. In certain instances and examples herein, the term “coupled” or “in communication with” means connected using either a direct link or indirect data link as is generally understood in the art. Moreover, the connections may be wired or wireless, private or public networks, or the like.

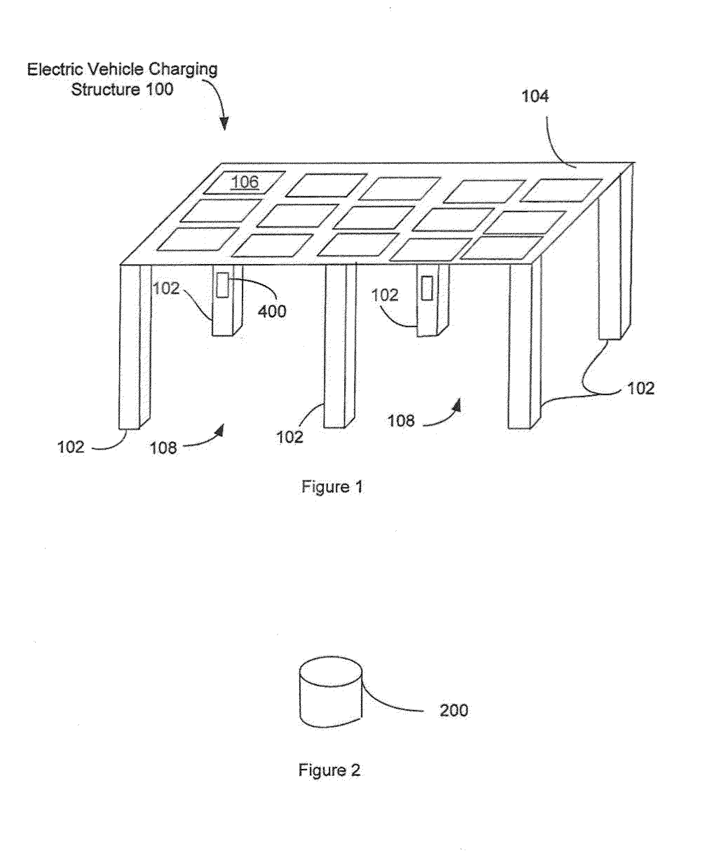

Referring first to FIG. 1, an electric vehicle charging structure 100 consistent with the technology of the present application is provided. The electric vehicle charging structure 100 includes one or more legs 102 to support a roof structure 104. A plurality of panels 106 reside on roof structure 104. In the shown exemplary structure, panels 106 are solar (photovoltaic) panels. Additionally, while shown as a 3×5 array, the panels 106 may be a single large scale panel, more, or less panels as a matter of design choice. Also, while shown fixed and relatively flat on roof structure 104, the panels 106 may be mounted at an angle to effectuate a more normal face to the sun or other light source. Also, as shown in FIG. 2, one or more of the solar panels 106 may be mounted on a pedestal 200 that allows panel 106 to rotate such that the panel is more normal to the sun or other light source. As can be appreciated, the electric vehicle charging structure 100 is provided with two bays 108 to provide access for two electric vehicles to a charge station 400. More or less bays may be provided. Also, while shown as an open bay, one or more walls may be provided between the support legs 102 for privacy or protection from the elements, etc. Also, roof structure 104 may be designed to allow pivoting and rotational movement instead of mounting one or more of the solar panels 106 on pedestals 200.

While electric vehicle charging structure 100 is envisioned to contain one or more solar panels, in certain embodiments, the electric vehicle charging structure 100 may comprise one or more panels 106 that are heliostats instead of photovoltaic panels. Heliostats comprise one or more mirrors or highly reflective surfaces. Heliostats reflect sunlight or other light source onto a collector and are generally used for the production of concentrated solar power. Generally, heliostats are mounted on a pedestal, such as pedestal 200, such that the heliostat reflective surface can be moved to maintain an efficient or optimum angle with the light source as the light source (typically the sun) moves throughout the day. Concentrated solar power, unlike photovoltaic panels, uses the concentrated solar energy to produce heat, typically in the form of steam or some type of gas to drive a turbine.

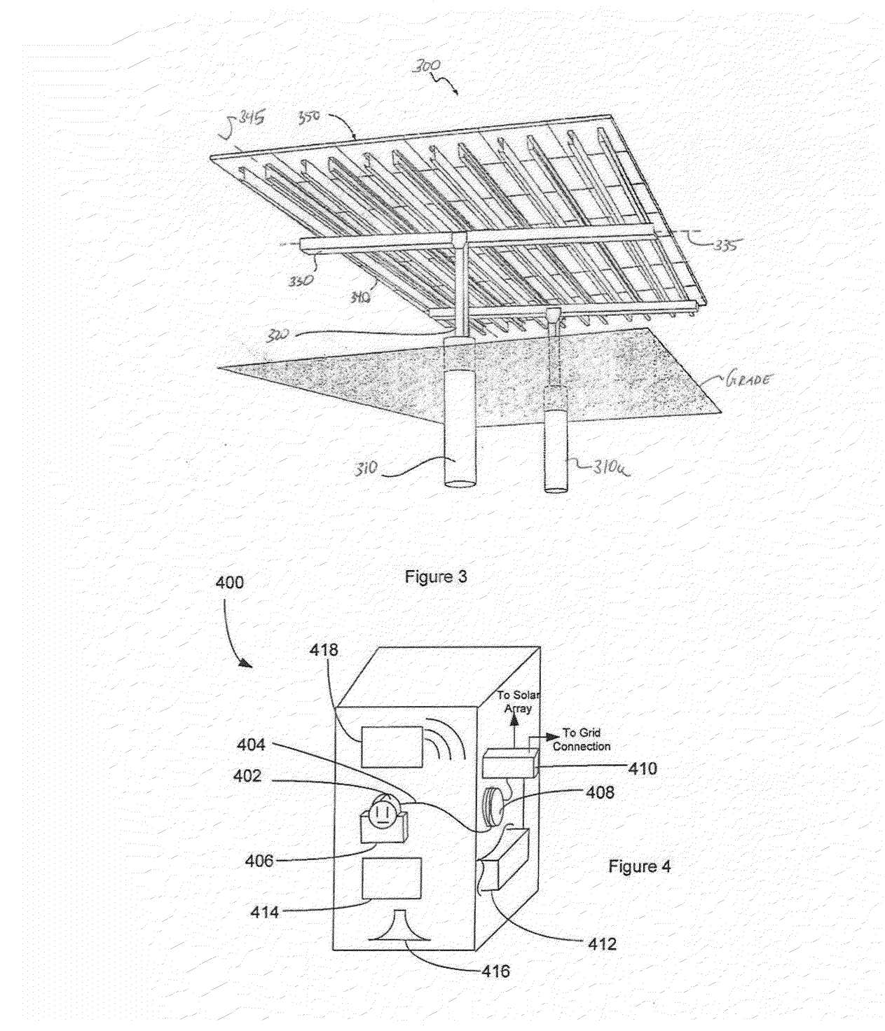

Referring now to FIG. 3, another electric vehicle charging structure 300 consistent with the technology of the present application is provided. The electric vehicle charging structure 300 has permanent anchors shown as support legs 320 attached to foundations 310 that have an extension 310u under grade level, which grade is shown by the shaded portion. Support legs 320 are coupled at an upper end to a beam 330. The beam 330 has a longitudinal axis extending in a first direction 335. Supported on beams 330 are a plurality of mounting beams 340. Mounting beams 340 have a longitudinal axis extending in a second direction 345 substantially perpendicular to the first direction 335. A conventional solar panel array 350 is arranged on mounting beams 340.

Electric vehicle charging structure 100, sometimes referred to as a solar canopy, is shown presently as a permanent or semi-permanent structure. However, it would be possible to provide wheels or the like on legs 102 to allow portability. Also, the structure may be made in a modular design to allow relatively fast disassembly and reassembly. In certain embodiments, the solar panels may be attached to collapsible structures such that the solar canopies may be expanded for use in particular locales and collapsed for storage or movement.

While shown as open access structures, both structures 100 and 300 may be provided with walls and a door, such as, for example, a garage door, that may lock or be electronically controlled. In certain aspects of the technology of the present application, the bays 108 may be accessible by only certain subscribers to the electric vehicle charging network. As will be explained further below, the bay may be provided with a wireless device that establishes a communication link with a wireless device of a user attempting to access the bay. If the user has a certain membership level, loyalty, or other criteria, the bay unlocks to allow the door to open, such as by an automated door, to allow the designated user access to the bay. In certain embodiments, instead of unlocking to allow access, access may be permitted even if the membership level, loyalty, or the like is not met. For this exemplary embodiment, the improper access may result in a penalty, such as, for example, a fee to the membership account, a registered charge card, a denial of certain services, or the like.

Referring to FIG. 4, a charge station 400 is shown in more detail. Charge station 400 includes a plug 402 and cord 404 adapted to be coupled to a battery, such as an electric car vehicle battery or another battery. The plug 402 includes a cradle 406 for the plug and a reel 408 that allows the cord to be extended and retracted. The cord is connected to the plug 402 on a first end and connected to a power conditioner 410 on a second end. The plug 402 could be either a male or a female plug. Alternatively, a plurality of plugs 402 may be provided where a certain number of plugs 402 are male and a certain number of plugs 402 are female. Also, cord 404 does not need to be extendable or retractable as the electric vehicle may have a plug that is coupled to an extendible cord. In these instances, the reel 408 may be optional and the plug 402 may be integrated to the charge station 400 without a cradle 406.

The power conditioner 410 provides the circuits, transformers, rectifiers, and the like necessary to convert the energy from the solar cells into a form conducive to charging the appropriate battery. Depending on the technology, the conditioning may or may not be necessary. While shown as coupled to the solar array, the power conditioner 410 may be connected to other forms of energy, such as, an electrical grid, a wind turbine generator, a concentrated solar reactor generator, etc. Additionally, the power conditioner 410 may accept inputs from multiple power sources, such as, for example, a combination of one or more of a solar array, a diesel generator, a battery, a power grid, a wind turbine, or the like. The power conditioner 410, as shown, is coupled to both plug 402 and storage facility 412. Storage facility 412 may be contained in charge station 400, removable therefrom, or accessible in some fashion, such as by opening a panel on charge station 400. Storage facility 412 may be a stand alone cabinet coupled to the charge station 400 as well. Storage facility 412 may include one or more high capacity energy storage devices (not specifically shown) to store energy when no load is attached to plug 402. Storage devices also may receive energy to store when a load is coupled via plug 402 or the like if the energy produced by the power supply is sufficient. In certain embodiments, the high capacity energy storage devices may be one or more vehicle batteries, such as, for example, vehicle batteries that may hold a charge, but are considered to be at the end of life for one or more reasons. Instead of coupling plug 402 to power conditioner 410, plug 402 may connect to the storage facility 412 to supply power to vehicles or the like. In this exemplary embodiment, the energy source, such as photovoltaic panels 106, would charge the high storage capacitors or batteries in storage facility 412 and the energy to charge the vehicle battery, or the like, would be supplied via the energy stored in the storage facility 412. Notice, in certain embodiments, a cabinet may be provided with replacement vehicle batteries such that instead of charging the battery, a user could swap a drained battery for a charged battery.

While not specifically shown, the EVC stations 100 may include electrical accessories that are coupled to the solar panels 106, the power conditioner 410 and/or the storage facility 412. The energy from one or more of these devices would power the electrical accessories. Such electrical accessories include the electronics to be described hereinbelow, but also could include, without limitation, automatic doors, such as a conventional residential automatic garage door, lights, cellular micro arrays or towers, refrigeration units, high volume air conditioning equipment, to name but a few samples of possible electrical accessories. The electrical accessories may include one or more processors, such as a server, chip-sets, computers, as is generally known, which will be explained in more detail below, that power, for example, a graphical user interface 414 on charge station 300. Graphical user interface (GUI) 414 (not shown in any particular detail) may allow for input of data to fields on the GUI 414 using, for example, touch, such as by a touch screen, a light pen, a keyboard, or mouse, as are conventionally known and not shown in any particular detail herein. In one embodiment, the GUI 414 may allow a user of the equipment to select a charge level (such as 120V charge, 220V charge, 440V charge or the like, while the examples are typical multiples of residential power, other derivations of power are possible). The charge levels may be associated with the type of battery to be charged, such as an electric car battery charge may be selected at 440V; whereas, a mobile processor charge may be selected at 120V. The selection may be designated by the type of device and the processor (described below) would provide the proper output to plug 402. For example, the plug 402 may be selectively coupled to a plurality of output ports on power converter 410 or a single output from power converter 410 may have a variable resistive load to control the voltage level out of the power converter 410.

The electrical accessories may include a server 416, a radio transceiver 418, such as a conventional micro array or cellular tower, a WiFi access port, a Bluetooth wireless network, or any other wireless devices capable of interfacing with the Internet, such as, for example, a satellite transceiver or the like. The communication range of the various devices is generally limited in distance. Generally, a single WiFi hotspot may have a communication range of 80 less than 100 meters or in some embodiments, less than 200 meters. Similarly, microcells typically have a range of 200-300 meters. Whereas, linking a series of transmitters may provide coverage up to a few miles. The devices may subsequently connect to the Internet as will be explained below.

As can be appreciated, the capital costs associated with construction and installation of the above described solar canopies may be high and, in some instances, cost prohibitive. Thus, it is necessary to provide mechanisms, tools, and systems that are capable of offsetting the costs. In some embodiments, costs may be offset by a connection between the solar panels and the power grid such that extra energy may be sold to utilities. However, selling energy to the grid typically requires years before the capital costs are offset. Thus, the technology of the present application relates to providing location based advertising coordinated with the solar canopy, which will be explained in more detail below. The solar canopy will have one or more processors, servers, computers, mobile computing devices, and wireless transceivers that can coordinate with customers or users of the solar canopy as will be explained. Once the server associated with the solar canopy handshakes or couples to a user's mobile or car based device, the solar canopy may provide advertisements and the like to the user. The local stores would register with the solar canopy to provide advertisements, which may include deal of the day type of features. To reduce the capital construction costs, certain solar canopies may be provided (at least initially) without the ability to charge vehicles or other batteries. Rather, the solar canopy would provide what have been described as ancillary services. Once a revenue stream is established using the ancillary services, the solar canopies may be retrofitted with the capability to charge vehicles or other batteries.

In operation, a client would move an electric vehicle (or some other electric device) into a bay associated with the EVC station 100. The electric vehicle would be plugged to the charge station 400 using the plug 402. In certain embodiments, the charge station 400 is usable by registered members of the service, thus, electric power only is provided if the vehicle is a registered vehicle. The electric vehicle based processor, for example, may send a unique identifier associated with the vehicle to allow charge to flow. Alternatively, the client may use the GUI 414 to provide a password or other identifier. In still other embodiments, the client may provide a login via a smartphone or other mobile computing device to the service to begin the flow of power. In still other embodiments, the client may have an application on a mobile device, such as the smartphone, that transmits an identifier to the charge station 400 to allow access to the services contained therein. If the system is open to the public as well as members, a non-client user may be able to provide, for example, credit card or other payment information via the GUI 414. To facilitate credit cards, the GUI 414 may include a card reader as an input mechanism. In one exemplary embodiment, the charge for a kilo-watt/hr may be directly correlated to the electric utility charge for a kilo-watt/hr or the selling price on the electricity spot market. Alternatively, as electric vehicles are as an alternative to gas powered vehicles, the kilo-watt/hr charge may be tied to a price per liter or gallon of gasoline, diesel, or the like.

Power conditioner 410 also may be connected to the grid, as shown. Energy above the storage capability of the station may be sold to electric companies or local merchants, homes, or facilities (such as street lights, signs, etc). In certain aspects, the technology of the present application may relate to directly powering street lights, traffic lights, signs, or local buildings instead of being provided with capabilities to charge electric vehicles or other batteries.

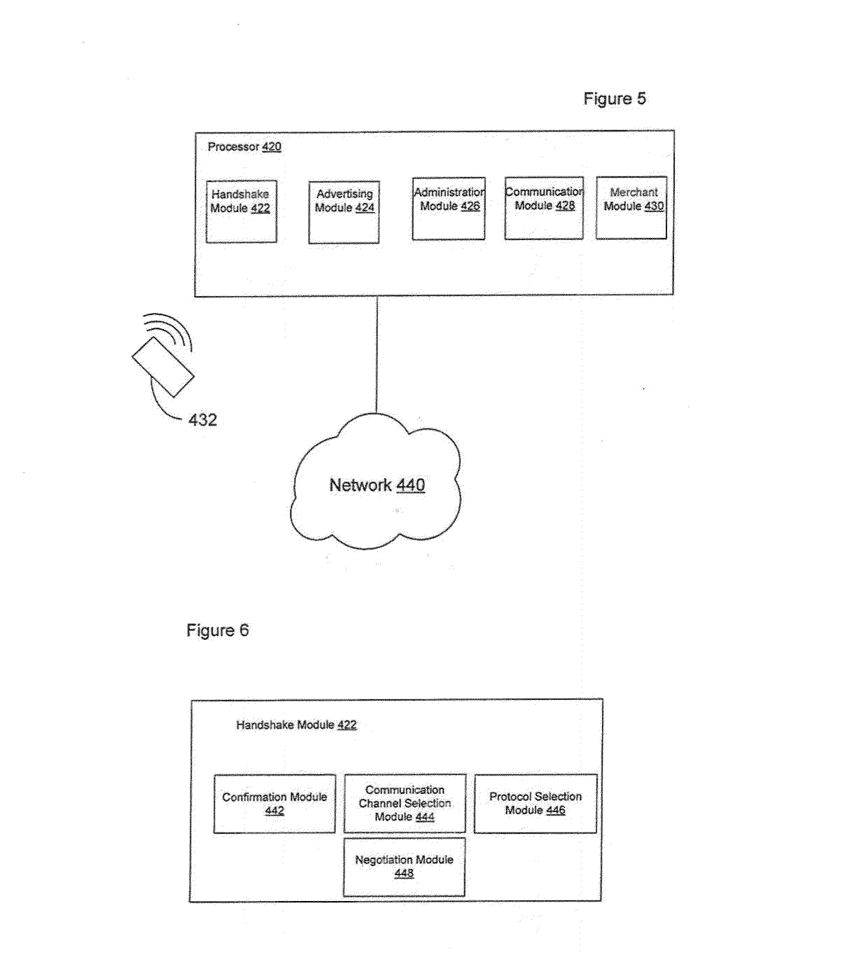

Referring now to FIG. 5, a processor 420 is shown and described that provides some aspects of the advertising methods disclosed herein. The processor 420 is connectable to the internet either directly or through an Internet Service Provider (ISP). In some embodiments, the processor 420 may have a different construction and/or configuration to permit access via some other type of computing system, network, or communication protocol. In one embodiment, for example, the processor 420 may be a micro-array or cellular tower that is connectable to the internet through the cellular telephone network.

Processor 420 may include a handshake module 422, an advertising module 424, an administration module 426, a communication module 428, and a merchant module 430. Of course, processor 420 may have any one of these modules, a combination of these modules, or additional modules in various configurations that are possible in accordance with the technology of the present application. Moreover, while shown as discrete modules, each of the modules may be combined or separated into less or more components as necessary to accomplish the functionality therein. Additionally, the modules may be contained locally in one or more networked processors 420. In certain embodiments, one or more of the modules may be located remotely from the processor 420. As will be explained in more detail below, the processor 420 is interconnected to a network 440.

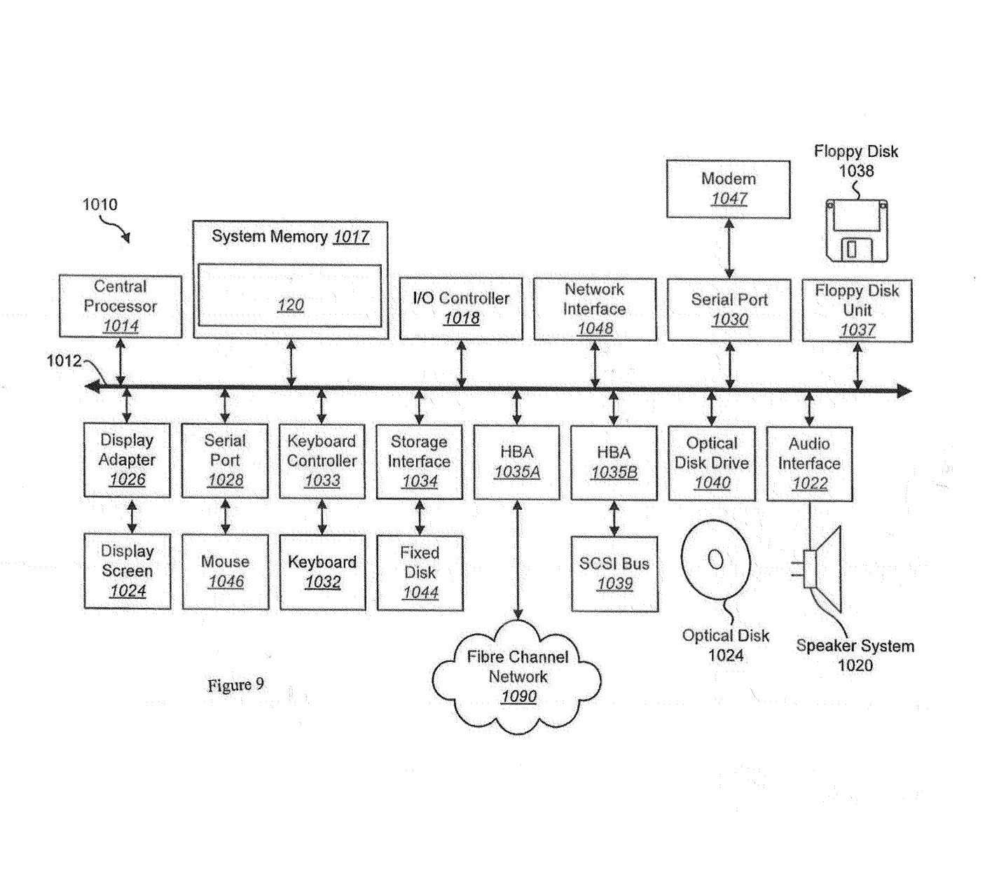

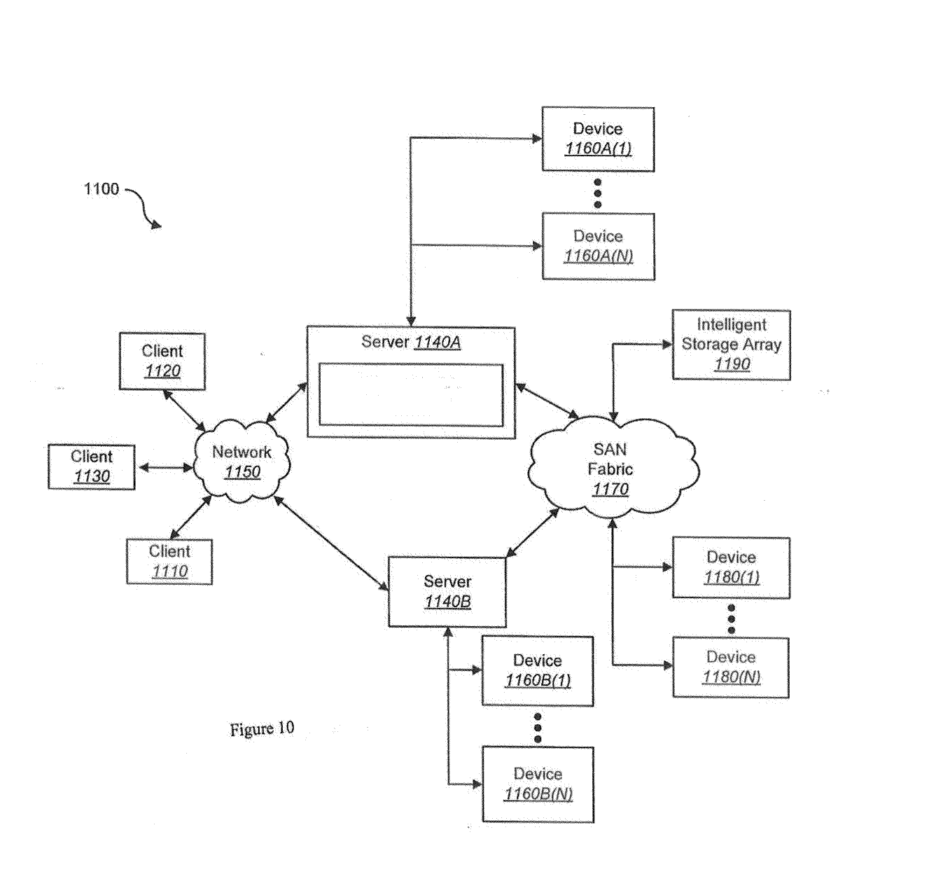

Each of the processor and modules may provide a unique function and may operate using, for example, a computer system such as the computer system described below with reference to FIG. 9 or network architecture as described below with reference to FIG. 10.

Referring now to FIG. 6, the handshake module 422 is described in additional detail. For reference, handshaking is the automated process by which communication channels are dynamically established between two devices. For example, handshaking module 422 may include a confirmation module 442, a communication channel selection module 444, a protocol selection module 446, and a negotiation module 448. The confirmation module 442 may, for example, identify when a vehicle is plugged into the charge station 300. Rather than plugged into the charge station 300, the floor of the port may have a weight sensor that confirms a user is in the port should the vehicle for whatever reason not be plugged into the charge station. Alternatively, especially in aspects of the technology in which a charge station 300 is not provided, the confirmation module 442 may poll the vicinity to determine whether wireless devices are within a communication range of the device to allow handshaking. The confirmation module 442 may additionally confirm that the charge station 300 client has been either authorized as a registered user, such as the aforementioned login, or that the client has provided a payment mechanism, such as a credit card or monetary deposit. Once the user is confirmed, the handshake module 422 may, for example, have the communication channel selection module 444 select a communication channel or reserve an available communication channel for communication with the client. The channel selection may be a wireless or wired communication link between the processor 420 and a client device 432. The handshaking module may have the protocol selection module 446 to select the appropriate protocol for communication with the client device 432. For example, the transmission protocol may be a short message system protocol, an email protocol, a cellular connection, a session initiation protocol, a transmission control protocol, or the like. The protocol selected may be based on the client information if the client is registered with the service, or may be a coordination/synchronization between an application running on the client device 432 and one on the processor 420. The protocol selection module 446 may poll the client device 432 for an acceptable mechanism to exchange information. Finally, in this exemplary embodiment, the negotiation module 448 may negotiate the details for the communication including, in most instances, an invitation and an acceptance to communicate using a particular channel and a particular protocol. While the exemplary embodiment is described with respect to clients or users of the solar canopy, the processor 420 may interact with any wireless enabled device within its broadcast range assuming a communication link may be established.

During operation of the solar canopy, it is envisioned that processor 420 would connect via a WiFi, cellular, Bluetooth, or other protocol using radio transceiver 418 to a customer wireless device such as a smartphone, mobile processor (such as a handheld computer or laptop), a vehicle based device, or the like, generically referred to as the client device 432. As can be appreciated, each of the above connections provides for a predefined transmission range for the processor 420. Generally, the transmission range or detection range would be limited to a few blocks, a parking area, or the like. In certain embodiments, the transmission range may be between a few meters to about 300 meters. It is envisioned that the client device 432 would contain an application to enable the connection to processor 420, which connection may be facilitated by the use of a unique identifier associated with the client device 432. In certain aspects of the technology, a user would register with the service by downloading an application to client device 432. The application running or capable of being activated by a signal would interact with processor 420 when within range of the wireless device to facilitate the establishment of a communication link between the device and the processor. Communication between processor 420 and client device 432 is envisioned to be wireless through the transceiver associated with a conventional mobile client device 432 and radio transceiver 418 described above. In one embodiment, the wireless connection may be a secure connection where the unique identifier is used as a password to allow a communication link between processor 420 and client device 432. In still other embodiments, the client device 432 will need to transmit a password entered by the client. In yet other embodiments, the wireless connection may be an unsecured connection.

In certain aspects of the technology of the present application, the processor 420 may store in a memory, such as system memory 1017 in FIG. 9, the number of client devices 432 that enter and/or exit a service area of processor 420 for any given predetermined amount of time, such as a 24 hour period, a 30 minute period, a 3 day period, or the like. The service area of processor 420 for the purposes of this exemplary description of the technology may be any device that is within handshaking wireless access of the processor 420. Registering this information may allow the advertiser to identify the number of potential customers entering a particular geographical area or local, which may be associated with even a single storefront in, for example, a mall setting. However, while it is possible to monitor the number of unique client devices 432 that enter a service area, such information is potentially limiting in that a single family of 3 or more potential customers may collectively only have a single client device 432, such as a single cellular telephone, smartphone, or other mobile computing device. Similarly, a single individual in today's market may have several client devices 432. Each of which may offset the value of counting particular client devices.

Canopies 100 or 300 may be mounted with a camera, video recorder, thermal imaging, infrared beams, weight or pressure sensors, or the like to count the number of individuals (or vehicles) that pass within the video surveillance area of the camera. In these cases, processor 420, for example, would be programmed to recognize certain images as individuals or vehicles. Using this information, it may be possible to count the number of people or vehicles that access an area regardless of whether they have a client device 432. To the extent cameras are used to image individuals or vehicles, one particularly useful imaging device may include the KINECT® imaging system available from Microsoft, Inc., either alone or in combination with other imaging devices. The KINECT imaging device may be particularly useful as it can track an individual's movements as it interacts with the systems described herein. Vehicles also may be counted by, for example, a sensor cable placed across an access point instead of via a camera or imaging device that measures the number of axles that cross the cable. Moreover, processor 420 may be provided with or have access to facial recognition software. Thus, a high resolution camera may be capable of providing not only the number of people that pass a particular canopy, but in certain aspects, may be capable of providing metrics relating to the individual. The metrics may include sex, race, ethnicity, age, height, weight, or the like. In still certain aspects, the facial recognition may allow for identification of particular individual's identities.

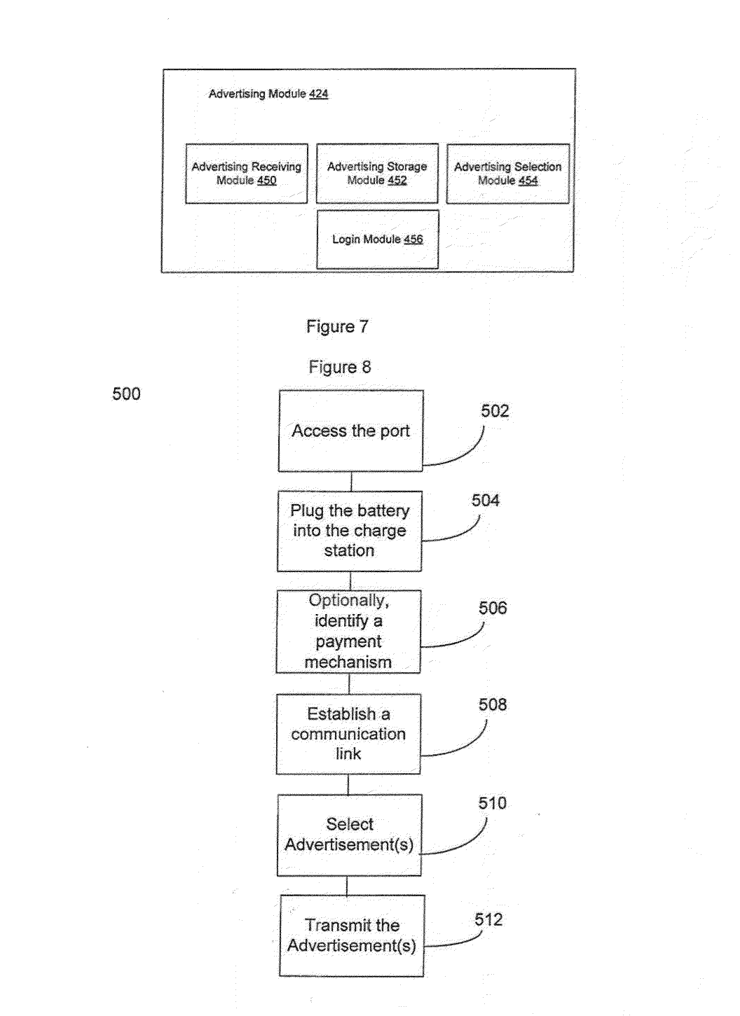

Referring now to FIG. 7, the advertising module 424 is shown in additional detail. The advertising module 424 may include an advertising receiving module 450, an advertising storage module 452, and an advertising selection module 454. Optionally, the advertising module 424 may require merchants to pre-register with a service. In this case, advertising module 424 may include a login module 456. Advertising receiving module 450 may, for example, provide an interface accessible via a website that allows local merchants and establishments to upload information to be broadcast to users of the technology described herein. The advertising receiving module 450 transfers the uploaded information from the interface to the advertising storage module 452 for the service to retain the advertising (notice the storage may be locally or remotely—for example, the merchant's processors may store the actual advertisements). The interface would allow a merchant to add advertising, modify existing advertising, or remove advertising. Also, the interface may provide a plurality of advertising options to the potential merchants. For example, a merchant may elect a basic subscription service that generates a certain level of advertisement traffic or a more advanced service that generates high traffic of advertisement and may allow for special advertising, such as, for example, participation in a “deal-of-the-day” type of advertising. The advertising selection module 454 would select a particular advertisement from the one or more advertisement options stored in advertising storage module 452. The selection may be based on multiple criteria, such as, for example, a random selection, a selection based on a number of advertisements that must be distributed for a particular level of service, a deal of the day option, a holiday selection, etc. Generally, the transmitter has a known location with a known transmission range. The selected advertisement may be based on the proximity of the merchant to the location, which may be determined by distance, zip code, or the like. The selected advertisement is transmitted to the client device 432; however, it is possible to provide the advertisements to any wireless devices in the broadcast range of the transceiver.

The login module 456 is associated with a paid for advertising service where the merchant becomes a member of the service and authorized to advertise using the same. Registration may require selection of a membership status, wherein each status may provide certain benefits and may have an associated cost. In one example, the merchant may select among bronze, silver, and gold membership status, wherein each status permits, for example, posting of a certain number of advertisements or types of advertisements and products, etc.

The administration module 426 provides an administrator to manage the service provided through the structures and processor 420. The administrator module may monitor merchant and user accounts and invoice the same as required including running transactions via payment mechanisms, such as, if a non-registered user swipes a credit card or the like. The merchant module 430 provides a mechanism to allow a merchant to monitor its account. The merchant would be provided a unique identification or may select a unique identification code. The merchant module 430 may allow the merchant to monitor the number and type of advertisements transmitted, redemptions of the advertisements, costs, times of transmissions, etc. The communication module 428 may provide communication between the various devices and networked connections. For example, the communication module 428 may coordinate access by the client device 432 to external websites via the network 440.

Referring now to FIG. 8, an exemplary method 500 of using the technology of the present application is provided. A step 502 includes accessing the bay 108 by, in certain exemplary embodiments, driving an electric vehicle into the bay 108. In a step 504, the client plugs the electric vehicle to the plug 402. Once plugged, the system may identify a payment mechanism at a step 506, such as, for example, recognizing the client as a registered member or recognizing an alternative payment option, such as providing a credit card to the GUI 414. In certain embodiments, payment may not be required to access the service removing the need for step 506. Steps 502 to 506 may be optional for solar canopy stations that only provide ancillary services. Charge station 400 at a step 508 establishes a communication link between the processor 420 and the client device 432, as explained above. The communication link is envisioned to be with a client mobile device but may be with a device associated with the vehicle. In a step 510, one or more advertisements are selected for transmission to the client device. The selection may be based in part on the proximity of the merchant to the transmitter. Finally, the selected advertisements are transmitted to the client device in a step 512. The transmission may be any number of mechanisms depending on the protocol selected, as explained above, and could use a short message system, an email system, a telephone or cellular phone call, a streaming system, a download, or the like.

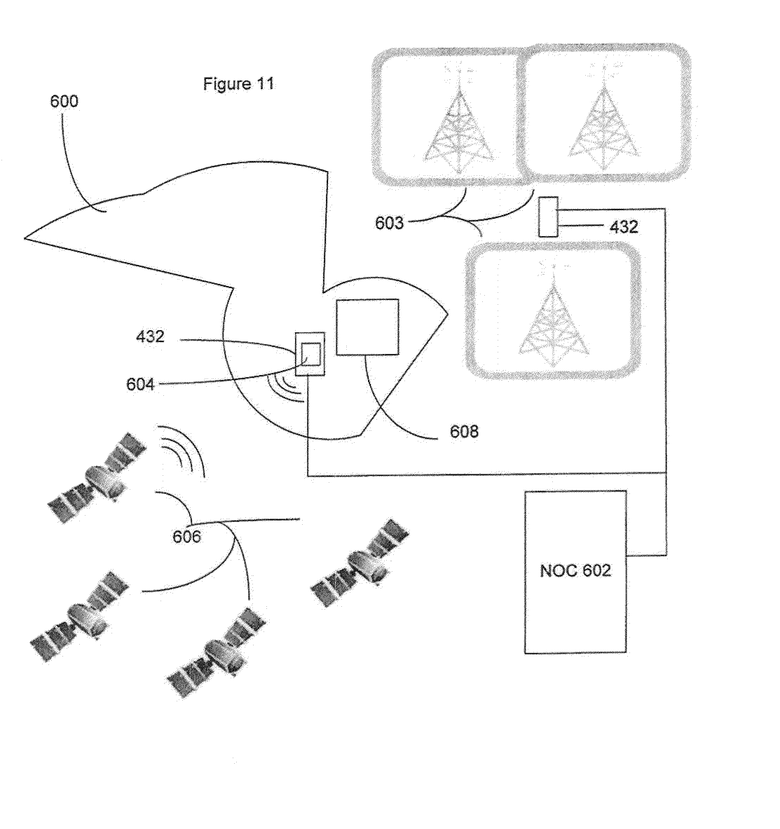

Referring now to FIG. 11, it may be possible to further tune the above described system to provide more location specific information. In particular, the above described technology relates to providing available advertisements uploaded by local establishments to be downloaded to client devices 432 or the like depending on relative location between the merchant and the client device 432. It is possible using more exact tracking measures to determine the real time or near real time location of one or more client devices 432 in a particular area and transmit, for example, a Starbucks® coffee coupon to the client device as the client is walking past or into a coffee shop. With specific regards to FIG. 11, a geo-fence 600 may be established in which local merchants, shops, etc. may be registered. In this exemplary embodiment, the geo-fence 600 is a random shape. The shape, however, may be regular, such as a polygon or elliptical shape, or random as shown. For example, in certain embodiments, the geo-fence 600 may be established around a mall, a city block(s), a particular establishment, or the like. The geo-fence boundary may be programmed by a coordinate system such as using, for example, the World Geodetic System (“WGS84”), the last rendition of which was in 1984. The client would register the client device 432 with a centralized network operations center 602, which may be one or more servers, computers, chip-sets, or the like. Using various passive tracking mechanisms currently available, such as, for example, triangulation via cellular towers 603 connection and signal strength, the network operations center 602 can determine the approximate location of the client device 432 relative to certain cellular tower signals. The position of the cellular towers is referenced to the coordinate system, such as the WGS84. Thus, the relative position of the client device may be superimposed onto the coordinate system. At predetermined times (or random times), the network operations center 602 would determine the position of the client device 432 using one of the passive tracking mechanisms, which are typically accurate to approximately 100 meters. The network operations center 602 would compare the location of the client device 432 to the geo-fenced area to determine whether the client device 432 is in a geo-fenced area 600. The client device 432 is shown in two separate positions in FIG. 11, one inside the geo-fence 600 and one outside the geo-fence 600. Due to accuracy, the geo-fenced area 600 may be overlarge and/or the position of the client device 432 within a certain distance of the geo-fence area 600 may be sufficient to trigger the application as explained further below. Once it is determined the client device 432 is in a geo-fenced area 600, the network operations center 602 would send a signal to activate a global positioning system 604 on the client device 432. The GPS 604 would coordinate with overhead satellites 606 to triangulate the specific position of the client device 432 with an accuracy of less than a meter in many applications. The specific location of client device 432 can be coordinated within the geo-fenced area 600 by the network operations center 602. Alternatively, if solar canopies as explained above are available, the tracking may be coordinated by triangulating the client device 432 with the locally based known positions of the solar canopies. This tracking mechanism could use conventional triangulation and location determination methods and algorithms, but should have a better accuracy than triangulation using cellular towers 603 as the solar canopies are located in relatively close proximity. While the tracking likely would not be as accurate as a GPS transceiver, the tracking may be sufficiently accurate to justify the reduced battery draw of the GPS transceivers. Also, using the solar canopies for more accurate triangulation would allow devices without GPS transceivers to use the technology herein. Merchants 608 would similarly register with the network operations center 602. Each merchant 608 would provide the specific coordinates to the network operations center 602 such that the merchant 608 may be located within the geo-fenced area 600. Once activated, the network operations center 602, using the GPS 604, would track the client device 432 in real or near real time. The actual location would be compared to the merchant 608 coordinates to determine whether the client device 432 is within a predetermined distance of a local establishment. The predetermined distance may be as little as less than 1 meter to as much as about 10 meters, although other distances are possible. Once within a determined distance of the merchant 608, the network operations center 602 would review the advertising module 424, for example, to determine whether the merchant 608 has any available advertisements, coupons, texts, or the like available for delivery to the client via the client device 432. The network operations center 602 would deliver the advertisement through the communication link established via processor 420, for example. This would allow detailed transmission of location specific information to the client to enhance the probability that the client would receive the information and act on the same due to the timeliness and location specific receipt of the information.

The above geo-fencing application may be beneficial to many existing applications that currently operate for social networking and other purposes. For example, certain smartphone applications allow users to “check-in” at particular venues. The smartphone is configured to upload its location to a website that may alert “friends” or associates of the user's location and other local establishments. In many applications, the users must be both at the establishment and manually invoke the application or execute the application such that the system “checks in” the user. Using the present technology, however, it would be possible to activate a geo-fence associated with the establishment such that when a user first checks into a particular location, the geo-fence is activated for that user. The system, as described above, would passively track the user and, on entering the geo-fenced area, automatically check the user into the establishment. The application would also be automatically invoked on the smartphone by the service once the location of the user has been determined. Establishment of the geo-fence may be accomplished by registering the establishment, similar to as described above, or the geo-fence may be established automatically by the service when a user checks in at a particular place. For pre-registered establishments, the automatic check-in feature would function the first time a user enters the geo-fenced area. For other establishments, the users would need to manually check in at an establishment the first time. The GPS (or other tracking device if not GPS) would identify the location of the user and coordinate the specific location with an address, using any of a plurality of on-line available mapping systems, such as Google maps, Map-Quest, etc. The map would be coordinated with a coordinate system to establish the boundaries of the address (or at least the entry and exit points) such that a geo-fence may be established for the establishment such that the next time a user enters the establishment, such as a friend joining the original user, the geo-fence would be established and the friend's device 432 would be automatically checked into the establishment.

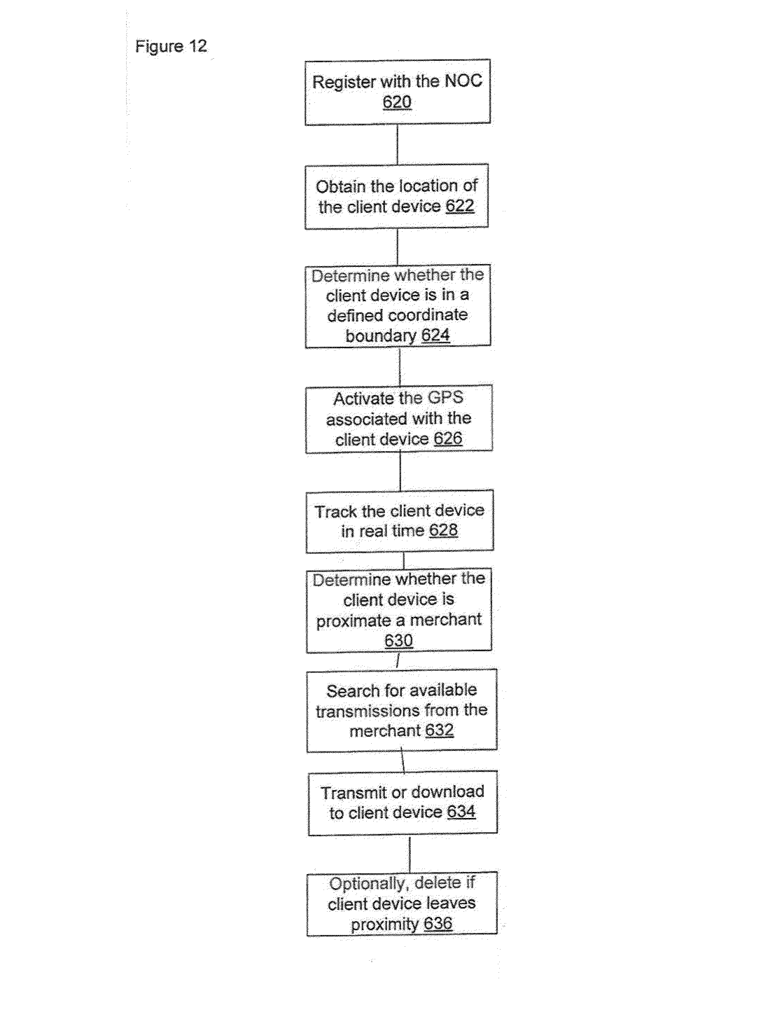

Referring next to FIG. 12, a method of implementing the technology described with respect to FIG. 11 that is consistent with the present application is provided. In a first step 620, the client would register the client device, such as client device 432, with a network operations center 602. This would provide the network operations center 602 with permission to track the client, which may be required in certain jurisdictions in regards to privacy laws. The network operations center 602 would, in the normal course, receive and/or calculate the location of the client device 432, step 622. Often the client device 432 uses information from the cellular network to identify its location. In some cases, the client device 432 coordinates with a location-based service (LBS) to determine the location. Thus, network operations center 602 may incorporate a LBS or may receive the coordinates of the client device 432 over the network. In any event, the network operations center 602 obtains the coordinates of the client device. At a step 624, the network operations center 602 would next determine if the coordinates of the client device 432 are located in (or within a predetermined distance) of a geo-fenced (or some other identified coordinate system). If the network operations center 602 (which may, in fact, be contained in the client device 432 itself) determines the client device 432 is in a geo-fenced area, the GPS associated with client device 432 is activated, step 626. Alternatively, the GPS may be continually on; however, this is not a desirable solution as the GPS transmitter consumes a large amount of energy that drains the mobile device battery quickly. Once the GPS is activated, the network operations center 602 tracks the client device 432 based on the coordinate system in real time or near real time, step 628. Substantially at the same time that the network operations center 602 is tracking the client device, it is determining the proximity of the client device 432 to one or more merchants 608, step 630. When the proximity of the client device 432 to one of the merchants 608 is within a certain range, the network operation center 602 searches the advertisements available for the merchants, step 630, and transmits/downloads the advertisement to the client device 432, step 632. The client using client device 432 may be notified of the transmission/download as appropriate. The transmission/download may be a HTML download, a SMS message, a voice message, a call, an email, or the like. Optionally, the provided advertisement may be deleted automatically if the file is not accessed prior to the client device 432 exiting the proximity area. The proximity area for receiving the download may be a first range, and the proximity area for automatic deletion of the download may be a second range.

FIG. 9 depicts a block diagram of a computer system 1010 suitable for implementing the present systems and methods. Computer system 1010 includes a bus 1012 which interconnects major subsystems of computer system 1010, such as a central processor 1014, a system memory 1017 (typically RAM, but which may also include ROM, flash RAM, or the like), an input/output controller 1018, an external audio device, such as a speaker system 1020 via an audio output interface 1022, an external device, such as a display screen 1024 via display adapter 1026, serial ports 1028 and 1030, a keyboard 1032 (interfaced with a keyboard controller 1033), multiple USB devices 1092 (interfaced with a USB controller 1090), a storage interface 1034, a floppy disk drive 1037 operative to receive a floppy disk 1038, a host bus adapter (HBA) interface card 1035A operative to connect with a Fibre Channel network 1090, a host bus adapter (HBA) interface card 1035B operative to connect to a SCSI bus 1039, and an optical disk drive 1040 operative to receive an optical disk 1042. Also included are a mouse 1046 (or other point-and-click device, coupled to bus 1012 via serial port 1028), a modem 1047 (coupled to bus 1012 via serial port 1030), and a network interface 1048 (coupled directly to bus 1012).

Bus 1012 allows data communication between central processor 1014 and system memory 1017, which may include read-only memory (ROM) or flash memory (neither shown), and random access memory (RAM) (not shown), as previously noted. The RAM is generally the main memory into which the operating system and application programs are loaded. The ROM or flash memory can contain, among other codes, the Basic Input-Output system (BIOS) which controls basic hardware operation such as the interaction with peripheral components or devices. For example, the gifting module 104 to implement the present systems and methods may be stored within the system memory 1017. Applications resident with computer system 1010 are generally stored on and accessed via a computer readable medium, such as a hard disk drive (e.g., fixed disk 1044), an optical drive (e.g., optical drive 1040), a floppy disk unit 1037, or other storage medium. Additionally, applications can be in the form of electronic signals modulated in accordance with the application and data communication technology when accessed via network modem 1047 or interface 1048.

Storage interface 1034, as with the other storage interfaces of computer system 1010, can connect to a standard computer readable medium for storage and/or retrieval of information, such as a fixed disk drive 1044. Fixed disk drive 1044 may be a part of computer system 1010 or may be separate and accessed through other interface systems. Modem 1047 may provide a direct connection to a remote server via a telephone link or to the Internet via an Internet service provider (ISP). Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present systems and methods. The devices and subsystems can be interconnected in different ways from that shown in FIG. 9. The operation of a computer system, such as that shown in FIG. 9, is readily known in the art and is not discussed in detail in this application. Code to implement the present disclosure can be stored in computer-readable medium such as one or more of system memory 1017, fixed disk 1044, optical disk 1042, or floppy disk 1038. The operating system provided on computer system 1010 may be MS-DOS®, MS-WINDOWS®, OS/2®, UNIX®, Linux®, or another known operating system.

FIG. 10 is a block diagram depicting a network architecture 1100 in which client systems 1110, 1120 and 1130, as well as storage servers 1140A and 1140B (any of which can be implemented using computer system 1110), are coupled to a network 1150. In one embodiment, the gifting module 104 may be located within a server 1140A, 1140B to implement the present systems and methods. The storage server 1140A is further depicted as having storage devices 1160A(1)-(N) directly attached, and storage server 11408 is depicted with storage devices 1160B(1)-(N) directly attached. SAN fabric 1170 supports access to storage devices 1180(1)-(N) by storage servers 1140A and 1140B, and so by client systems 1110, 1120 and 1130 via network 1150. Intelligent storage array 1190 is also shown as an example of a specific storage device accessible via SAN fabric 1170.

With reference to computer system 1010, modem 1047, network interface 1048 or some other method can be used to provide connectivity from each of client computer systems 1110, 1120, and 1130 to network 1150. Client systems 1110, 1120, and 1130 are able to access information on storage server 1140A or 11408 using, for example, a web browser or other client software (not shown). Such a client allows client systems 1110, 1120, and 1130 to access data hosted by storage server 1140A or 11408 or one of storage devices 1160A(1)-(N), 1160B(1)-(N), 1180(1)-(N) or intelligent storage array 1190. FIG. 10 depicts the use of a network, such as the Internet, for exchanging data, but the present systems and methods are not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

I claim:

1. A renewable energy charge station comprising:
a renewable energy power source;
at least one processor operationally coupled to the renewable energy power source to receive power from the renewable energy power source;
an advertisement module operationally coupled to the at least one processor, the advertisement module providing at least one advertisement;
the at least one processor operationally coupled to a network; and
the at least one processor establishing a communication link with at least one mobile processor within a communication range of the at least one processor,
wherein the at least one advertisement module retrieves the at least one advertisement and the at least one processor transmits over the communication link the advertisement to the at least one mobile processor while the mobile processor is within the communication range of the at least one processor.

2. The renewable energy charge station of claim 1 wherein the renewable energy power source comprises a solar panel coupled to a solar canopy structure, the solar canopy structure comprising a plurality of legs and at least one roof forming at least one bay.

3. The renewable energy charge station of claim 1 further comprising a connection to an electrical power grid and wherein the at least one processor receives power from the electrical power grid.

4. The renewable energy charge station of claim 1 wherein the at least one processor establishes a communication link with the at least one mobile processor by receiving a unique identifier from the at least one mobile processor.

5. The renewable energy charge station of claim 1 wherein the at least one mobile processor is selected from a group of mobile processors consisting of: a cellular telephone, a smartphone, a laptop computer, a handheld computer, or a vehicular processor.

6. The renewable energy charge station of claim 1 further comprising a power conditioner coupled to the renewable energy power source.

7. The renewable energy charge station of claim 6, wherein the power conditioner conditions the power from the renewable energy power source to power a battery selectively coupled to the renewable energy charge station.

8. The renewable energy charge station of claim 6, further comprising a storage facility coupled to the power conditioner.

9. The renewable energy charge station of claim 8, wherein the storage facility comprises a plurality of end of life electric vehicle batteries.

10. The renewable energy charge station of claim 8, wherein the storage facility comprises at least one electric vehicle battery removably coupled to the storage facility wherein a battery of an electric vehicle may be swapped with the removably coupled electric vehicle battery.

11. The renewable energy charge station of claim 1, wherein the at least one processor counts a number of wireless devices within the communication range over a defined period of time.

12. The renewable energy charge station of claim 1, wherein the communication link is a short message system.

13. The renewable energy charge station of claim 1, further comprising an imaging device coupled to the at least one processor wherein the processor receives images from the imaging device and determines a number of individuals that enter an area imaged by the imaging device.

14. The renewable energy charge station of claim 13, wherein the imaging device tracks movement of individuals that enter the area.

15. The renewable energy charge station of claim 13, wherein the at least one processor comprises a facial recognition module.

16. The renewable energy charge station of claim 15, wherein the at least one processor identifies metrics of the individuals that enter the area based on the facial recognition module, wherein the metrics are selected from a group of metrics consisting of: sex, race, ethnicity, age, height, or weight.

17. A method of directing local advertisements to mobile processors comprising the steps of:
providing a renewable energy power source;
providing at least one processor having a defined wireless transmission range that receives power from the renewable energy power source wherein the at least one processor has a known location;
loading a plurality of advertisements to a memory operationally connected to the at least one processor;
detecting at least one wireless device within a transmission range of the at least one processor;
establishing a communication link between the at least one processor and the at least one wireless device;
selecting at least one advertisement from the plurality of advertisements, wherein the at least one advertisement corresponds to a business proximate the known location of the at least one processor; and
transmitting the at least one advertisement from the at least one processor to the at least one wireless device over the established communication link.

18. The method of claim 17 wherein the provided renewable energy power source comprises at least one solar canopy having photovoltaic cells and a power conditioner such that the electrical energy from the photovoltaic cells power the at least one processor.

19. The method of claim 18 further comprising the step of coupling a device having at least one battery to the solar canopy wherein the at least one battery receives power from the renewable energy power source.

20. The method of claim 19 wherein the device comprises a vehicle.
